(19) United States
(12) Patent Application Publication
(10) Pub. No.: US 2013/0157720 A1
(43) Pub. Date: Jun. 20, 2013

(54) TOWER MOUNT AMPLIFIER AND A METHOD OF USING THEREOF

(71) Applicant: CELLVINE LTD, Rosh Haayin (IL)

(72) Inventor: Yoni SCHIFF, Yahud (IL)

(73) Assignee: CELLVINE LTD, Rosh Haayin (IL)

(21) Appl. No.: 13/719,243

(22) Filed: Dec. 19, 2012

Related U.S. Application Data
(60) Provisional application No. 61/577,096, filed on Dec. 19, 2011.

(51) Int. Cl. H04W 88/08

(52) U.S. Cl. CPC H04W 88/08
USPC 455/561

(57) ABSTRACT

The subject matter discloses a tower mount amplifier device (TMA device), comprising a reception circulator for receiving a reception signal transmitted from an antenna to a base station and a low noise amplifier unit for amplifying the reception signal. The TMA device also comprises a band pass filter for filtering the reception signal amplified by the low noise amplifier unit and a transmission circulator for transmitting the reception signal filtered by the band pass filter to the base station. In some cases, the tower mount amplifier further comprises a switch for switching the signal from the reception circulator directly to the transmission circulator, wherein the switch operates according to a functionality of the low noise amplifier unit.

### BACKGROUND OF THE INVENTION

1. Field of the Invention

The present invention relates generally to the field of base station architecture in the cellular frequency range and more particularly to a device that is used to increase uplink channel sensitivity and compensate for cable losses.

2. Discussion of the Related Art

A TMA (Tower Mount Amplifier) or TTA (Tower Top Amplifier) is a device installed near a cellular antenna and uses a very low NF amplifier to amplify the uplink signals. In the downlink path, the device is transferring the transmissions with minimal losses.

The base station has two-way communications: transmit a coverage signal to the costumer's cell phone-downlink channel (DL). In the other direction, receive signal from the costumer cell phone-uplink channel (UL). Since the base station antenna is in most cases is not located close to the base station there is performance degradation due to RF cable losses. Therefore, there is a need to compensate for these cable losses especially in the UL channel to improve, the coverage range of the BTS (that is the ability to service more mobile phones at larger distances). This is made by a TMA device. The TMA device is installed on the tower near the coverage/reception antenna and is connected in series with this antenna RE cables.

The TMA has amplification of 5-20 db in the UL channel and no amplification in the DL base station transmission channel. The TMA is a device that is used very often by the cellular operators.

### SUMMARY OF THE INVENTION

It is an object of the present invention to propose an alternative architecture of the TMA in order to reduce the TMA components cost and improved performances.

The traditional Structure of the TMA consists of a duplexer and LNA. The duplexer if a high cost & size component that is used to separate the uplink and downlink channels. The proposed architecture will eliminate the use of duplexer by using circulators, filters and isolators.

It is an object of the subject matter to disclose a tower mount amplifier (TMA), comprising: a reception circulator for receiving a reception signal transmitted from an antenna to a base station and a low noise amplifier unit for amplifying the reception signal. The TMA device also comprises a band pass filter for filtering the reception signal amplified by the low noise amplifier unit and a transmission circulator for transmitting the reception signal filtered by the band pass filter to the base station.

In some cases, the tower mount amplifier further comprises a switch for switching the signal from the reception circulator directly to the transmission circulator, wherein the switch operates according to a functionality of the low noise amplifier unit. In some cases, the switch is a bypass switch connected to a bypass line. The bypass switch is configured to enable the TMA device to operate in cases of problematic functionality. Such cases may be failure of the LNA unit or failure of DC voltage supply.

In some cases, the tower mount amplifier further comprises a control unit for transmitting an instruction to the switch on whether to transmit the signal to the low noise amplifier unit or transmit the signal directly to the transmission circulator. In some cases, the tower mount amplifier further comprises a detection unit for detecting the functionality of the low noise amplifier unit and transmitting data related to the functionality of the low noise amplifier unit to the control unit.

In some cases, the transmission circulator transmits transmission signals from the base station to the antenna.

In some cases, the tower mount amplifier further comprises an LNA protection mechanism for filtering a fraction of the transmission signal directed from the transmission circulator to the low noise amplifier unit. In some cases, the tower mount amplifier further comprises a base station protection mechanism for filtering a fraction of the reception signal directed from the reception circulator to the base station via a transmission channel.

In some cases, the TMA device further comprises a first LNA filter located before the LNA unit and a second LNA filter located after the LNA unit. The first LNA filter and the second LNA filter allow only Uplink signals to enter the LNA unit. These filters also protect from residual Downlink signals to enter the LNA and cause unwanted compression.

It is an object of the subject matter to disclose a method of operating a TMA device, comprising receiving a reception signal from an antenna. Said reception signal is to be transmitted to a base station via a low noise amplifier unit; detecting functionality of the low noise amplifier unit; determining whether to transfer the reception signal via the low noise amplifier unit or directly to the base station.

The switch can also be activated by disconnecting the DC voltage to the TMA device. In this case, the switch automatically transfers the reception signal via the bypass line and not via the LNA unit.

In some cases, the method further comprises transmitting an instruction to a switch, said instruction is based on the detected functionality of the low noise amplifier unit and transferring the reception signal via the low noise amplifier unit or directly to the base station according to the instruction. In some cases, the method further comprises filtering a fraction of the reception signal directed from the reception circulator to the base station via a uplink reception line.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a Tower Mount Amplifier (TMA) device used and known in the prior art, according to exemplary embodiments of the subject matter;

FIG. 2 shows a TMA device, according to exemplary embodiments of the subject matter;

FIG. 3 shows a method for operating a TMA device, according to exemplary embodiments of the subject matter;

FIG. 4 shows a schematic diagram of components assembling a TMA device, according to exemplary embodiments of the subject matter.

### DETAILED DESCRIPTION OF THE PREFERRED EMBODIMENT

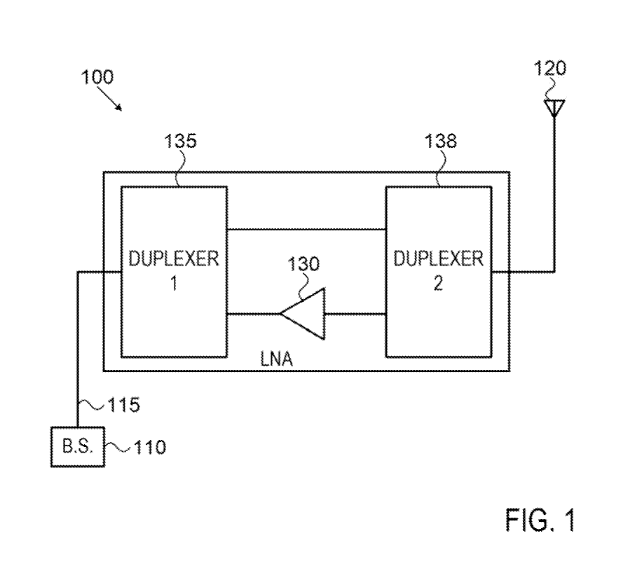

FIG. 1 shows a Tower Mount Amplifier (TMA) device used and known in the prior art, according to exemplary embodiments of the subject matter. The TMA device 100 of the prior art is connected to a Base station 110 via a base station communication line 115. The TMA device 100 may be placed on high poll on the base station house roof or on a high tower, near a coverage/reception antenna 120 via an antenna communication line 125.

The TMA device of the prior art comprises a Low Noise Amplifier (LNA) 130 and two duplexers, a transmission duplexer 135 and a reception duplexer 138. The transmission duplexer 135 and the reception duplexer 138 provide for bi-directional (duplex) communication over a single path and further provides for filtering the signal received from the coverage reception antenna 120. The two duplexers also isolate the receiver from the transmitter while permitting them to share a common antenna. A major drawback of duplexers used in a TMA device is that the attenuation of each of the duplexers is about 1-2 dB, which results in significant loss of intensity in both the transmitted signal and the received signal.

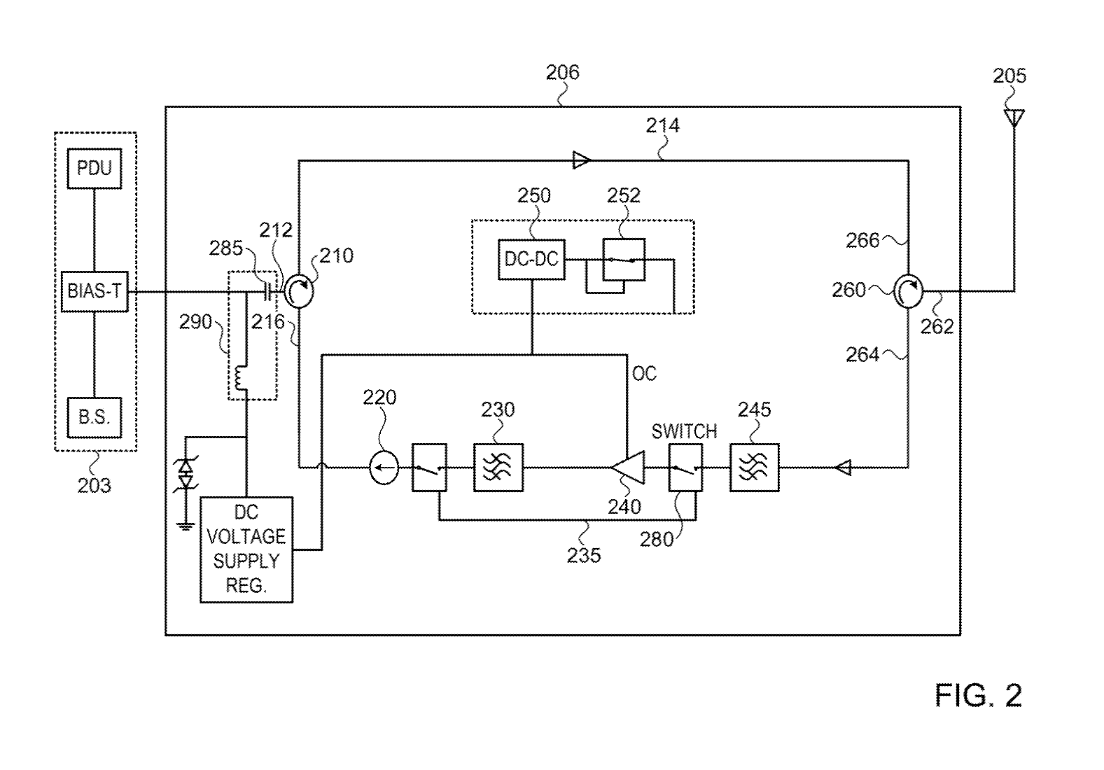

FIG. 2 shows a TMA device, according to exemplary embodiments of the subject matter. The TMA device 206 communicates with a base station 203 and an antenna 205. The TMA device 206 amplifies signal received from the antenna 205 to the base station 203 and further allows signal transmission from the base station 203 to the antenna 205.

The TMA device 206 comprises an LNA unit 240 for amplifying the received signal received from the antenna 205. The TMA device 206 further comprises a reception circulator 260 and a transmission circulator 210. Each circulator of the transmission circulator 210 and the reception circulator 260 is connected to three lines of communication. The reception circulator 260 receives a reception signal from the antenna 205 via reception communication line 262. Most of the reception signal is transferred to the LNA unit 240 via LNA communication line 264 and then to the base station 203. A fraction of the reception signal is transferred to an uplink reception line 266.

Similarly, the transmission circulator 210 receives a transmission signal from the base station 203 via transmission communication line 212 and transfers most of the transmission signal to the antenna 205 via antenna communication link 214. A fraction of the transmission signal is transferred to downlink communication channel 216 towards the LNA unit 240.

The reception circulator 260 and a transmission circulator 210 of the TMA device 206 provide significantly less attenuation than the duplexers' attenuation. The attenuation of the circulators is in the range of 0.2 to 0.5 dB. However, the circulators do not provide any filtering capabilities.

The TMA device 206 further comprises a band pass filter 230. The band pass filter 230 receives the reception signal after amplified by the LNA unit 240 and filters frequency band of a predefined range. The filtered signal is transferred to the transmission circulator 210 and then to the base station 203.

In some cases, the TMA device 206 further comprises an LNA protection mechanism 290 for filtering a fraction of the transmission signal directed from the transmission circulator 210 to the LNA unit 240 via downlink communication channel 216. The filter at the input of the LNA also rejects unwanted signals in other transmission bands to be amplified by the LNA unit 240.

In some cases, the TMA device 206 further comprises a base station protection mechanism 285 for filtering a fraction of the reception signal directed from the reception circulator 260 to the base station 203 via the uplink reception line 266.

In some cases, the TMA device 206 further comprises a switch 280 for switching the reception signal from the reception circulator 260 directly to the transmission circulator 210 via a bypass line 235. The switch 280 may operate according to a functionality of the LNA unit 240. A detector 252 may detect the functionality of the LNA unit 240. The functionality of the LNA unit 240 may be defined by lack of voltage supplied to the LNA unit 240 or malfunction of the LNA unit 240. In such cases, the switch 280 will transfer the reception signal from the reception circulator 260 directly to the transmission circulator 210 via the bypass line 235. The reception signal is then transferred from the transmission circulator 210 to the base station 203. The switch 280 may be an RF switch wirelessly transferring the signal.

In some cases, the TMA device 206 further comprises a control unit 250 for transmitting an instruction to the switch 280 on whether to transmit the reception signal to the LNA unit 240 or transmit the reception signal directly to the transmission circulator 210 via the bypass line 235. The control unit 250 is connected to the detector 252 for receiving data related to the functionality of the LNA unit 240.

In some cases, the TMA device 206 further comprises a cavity filter 245. The cavity filter 245 is used in case the reception signal is a reflection of a signal transmitted from the TMA device 206 to the antenna 205 and not received by the antenna 205. In such a case, the signal is returned to the TMA device 206 and may damage the LNA unit 240. The cavity filter 245 reduces the amplitude of the reflected signal before reaching the LNA unit 240. The cavity filter 245 filters the reception signal according to the frequency band of the LNA unit 240.

In some cases, the TMA device 206 further comprises an isolator 220. The isolator 220 receives the reception signal from the band pass filter 230 and transfers the to reception signal to the transmission circulator 210. The isolator 220 provides for protecting the LNA unit 240 in cases of high return loss from the antenna 205.

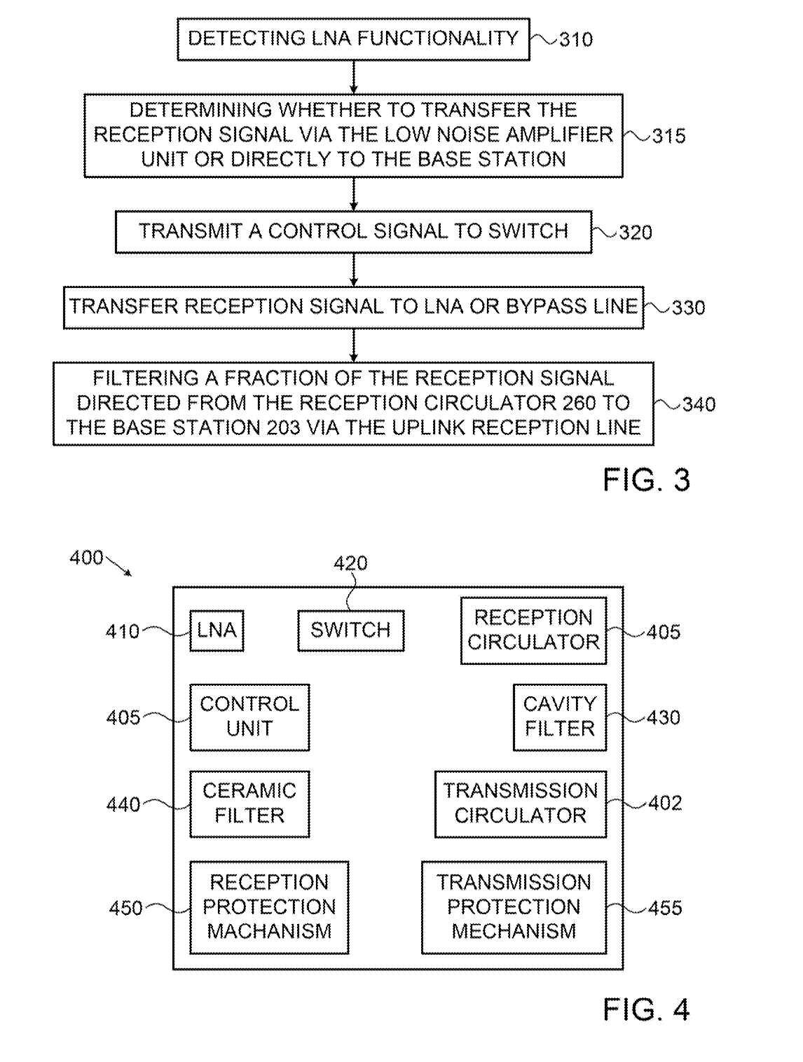

FIG. 3 shows a method for operating a TMA device, according to exemplary embodiments of the subject matter. Step 310 discloses detecting data related to the functionality of the LNA unit 240, such as lack of voltage supplied to the LNA unit 240 or malfunction of the LNA unit 240. Malfunction of the LNA unit 240 may be defined by amplifying a reception signal in a ratio lower than a predetermined threshold.

Step 315 discloses determining whether to transfer the reception signal via the low noise amplifier unit or directly to the base station. The control unit 250 may perform such determination according to a predetermined set of rules. Step 320 discloses transmitting an instruction from the control unit 250 to the switch 280. The control unit 250 may store a current operation state of the switch 280. The operation state may be selected from transferring the reception signal via the LNA unit 240 or transferring the reception signal directly to the transmission circulator 210 via a bypass line 235. The instruction sent from the control unit 250 to the switch 280 may be to change the operation state.

Step 330 discloses transferring the reception signal via the switch 280. The switch 280 transfers the reception signal to the base station 203 via two alternative options: 1. Via the LNA unit 240, 2. via the bypass line 235. When the reception signal is transferred via the bypass line 235, the reception signal is unamplified when received at the base station 203.

Step 340 discloses filtering a fraction of the reception signal directed from the reception circulator 260 to the base station 203 via the uplink reception line 266.

FIG. 4 shows a schematic diagram of components assembling a TMA device, according to exemplary embodiments of the subject matter. The TMA device 400 of the disclosed subject matter comprises a reception circulator 402. The reception circulator receives the reception signal from the antenna and forwards the reception signal to be amplified by the LNA unit 410. The LNA unit 410 amplifies the reception signal before transferred to the base station.

The TMA device 400 may further comprise a cavity filter 430 for filtering a transmission signal reflected back to the TMA device 400. Such transmission signal is reflected back in case an antenna is not receiving the signal transmitted from the TMA to device 400. The cavity filter 430 significantly reduces the intensity of the reflected signal to prevent any damage to the LNA unit 410 and to the base station via a transmission circulator 405. The cavity filter 430 also rejects unwanted signals in other frequency bands than a predefined frequency band used by the antenna.

The TMA device 400 may further comprise a switch 420. The switch is controlled by a control unit 425 connected thereto. The switch 420 may transfer the reception signal via the LNA unit 410 or directly to the base station. Determination on whether to transfer the reception signal via the LNA unit 410 or directly to the base station may be performed by the control unit 425. The control unit 425 perform such determination according to functionality of the LNA unit 410 using data received from a detector. Functionality of the LNA unit 410 may be defined, for example power failure to the LNA unit 410 or low intensity of the reception signal.

In case the reception signal is transferred via the LNA unit 410 and amplified therein, a band pass filter 440 then filters the reception signal. The pass filter 440 may be a ceramic filter, or any other filter desired by a person skilled in the art.

The TMA device 400 may further comprise a reception protection mechanism 450 and a transmission protection mechanism 455. Both protection mechanisms are required due to the use of circulators in the TMA device 400. As the transmission circulator 405 and the reception circulator 402 transfer a fraction of the signal to the wrong channel, such fraction may harm electronic components of the TMA device 400. The fraction of the signal may be in a range of 1-8% of the signal, in terms of amplitude. The reception protection mechanism 450 blocks or filters a fraction of the reception signal transmitted towards the base station via the uplink reception line. Similarly, the transmission protection mechanism 455 blocks a fraction of the transmission signal transmitted from the base station via the transmission circulator 405 to the LNA unit 410 at an opposite direction.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A tower mount amplifier, comprising:
a reception circulator for receiving a reception signal transmitted from an antenna to a base station;
a low noise amplifier unit for amplifying the reception signal;
a band pass filter for filtering the reception signal amplified by the low noise amplifier unit;
a transmission circulator for transmitting the reception signal filtered by the band pass filter to the base station.

2. The tower mount amplifier of claim 1, further comprises a switch for switching the signal from the reception circulator directly to the transmission circulator, wherein the switch operates according to a functionality of the low noise amplifier unit.

3. The tower mount amplifier of claim 2, further comprises a control unit for transmitting an instruction to the switch on whether to transmit the signal to the low noise amplifier unit or transmit the signal directly to the transmission circulator.

4. The tower mount amplifier of claim 3, further comprises a detection unit for detecting the functionality of the low noise amplifier unit and transmitting data related to the functionality of the low noise amplifier unit to the control unit.

5. The tower mount amplifier of claim 1, wherein the transmission circulator transmits transmission signals from the base station to the antenna.

6. The tower mount amplifier of claim 5, further comprises an LNA protection mechanism for filtering a fraction of the transmission signal directed from the transmission circulator to the low noise amplifier unit.

7. The tower mount amplifier of claim 1, further comprises a base station protection mechanism for filtering a fraction of the reception signal directed from the reception circulator to the base station via a transmission channel.

8. The tower mount amplifier of claim 4, further comprises an LNA protection mechanism for filtering a fraction of the transmission signal directed from the transmission circulator to the low noise amplifier unit and a base station protection mechanism for filtering a fraction of the reception signal directed from the reception circulator to the base station via a transmission channel.

9. A method of operating a TMA device, comprising:
receiving a reception signal from an antenna, said reception signal is to be transmitted to a base station via a low noise amplifier unit;
detecting functionality of the low noise amplifier unit;
determining whether to transfer the reception signal via the low noise amplifier unit or directly to the base station.

10. The method of claim 9, further comprises transmitting an instruction to a switch, said instruction is based on the detected functionality of the low noise amplifier unit and transferring the reception signal via the low noise amplifier unit or directly to the base station according to the instruction.

11. The method of claim 9, further comprises filtering a fraction of the reception signal directed from the reception circulator to the base station via a uplink reception line.
